(19) United States
(12) Patent Application Publication
(10) Pub. No.: US 2025/0273363 A1
(43) Pub. Date: Aug. 28, 2025

(54) Shielded Electric Wire and Conductive Non-Woven Tape

(71) Applicant: Yazaki Corporation, Tokyo (JP)

(72) Inventors: Hiroki Kondo, Susono-shi (JP); Satoko Hongo, Susono-shi (JP)

(21) Appl. No.: 19/044,231

(22) Filed: Feb. 3, 2025

Related U.S. Application Data
(63) Continuation of application No. PCT/JP2024/006865, filed on Feb. 26, 2024.

(51) Int. Cl. H01B 7/18

(52) U.S. Cl. CPC H01B 7/1855

(57) ABSTRACT

A shielded electric wire includes an electric wire and a conductive non-woven tape wound around the electric wire. The conductive non-woven tape includes a conductive non-woven fabric and an adhesive layer located on one surface of the conductive non-woven fabric, and is wound with a winding pitch of t/3 or more and t/2 or less to form a wrapped portion, where t is a width of the conductive non-woven tape. The adhesive layer is located in a different position from the wrapped portion, has an adhesive force of 2.0 N/19 mm or more measured by an adhesive force test in accordance with JIS C 2107, has a width of t/10 or more, and has a thickness of 0.01 mm or more and not more than a thickness of the conductive non-woven fabric.

### CROSS-REFERENCE TO RELATED APPLICATIONS

This is a continuation of International Application No. PCT/JP2024/006865 filed on Feb. 26, 2024, and the entire content of which is incorporated herein by reference.

### TECHNICAL FIELD

The present invention relates to a shielded electric wire and a conductive non-woven tape.

### BACKGROUND ART

In the related art, a shielded electric wire has been proposed in which a conductive non-woven fabric including a non-woven fabric and a metal layer formed on a surface of the non-woven fabric is disposed on an outer periphery of an electric wire. The shielded electric wire exhibits an electromagnetic shielding effect due to the metal layer of the conductive non-woven fabric, and can be easily bent because the non-woven fabric has excellent stretching and compressing properties. Further, a conductive non-woven tape has been proposed that includes a conductive non-woven fabric and an adhesive layer laminated on one of front and back surfaces of the conductive non-woven fabric. The conductive non-woven tape can be attached to a periphery of the electric wire by using the adhesive layer.

As for details of the above shielded electric wire, refer to JP2019-075375A, P2021-140950A, and JP2021-103775A.

Examples of an attaching method of attaching the conductive non-woven tape to a periphery of the electric wire in the related art include a method (so-called longitudinal attachment) of attaching the conductive non-woven tape to the electric wire in a state in which both ends of the conductive non-woven tape in a width direction are overlapped while the conductive non-woven tape is placed on the electric wire such that a longitudinal direction of the conductive non-woven tape and an axial direction of the electric wire coincide with each other. In a shielded electric wire manufactured by this attaching method, when the shielded electric wire is bent, the both ends of the conductive non-woven tape are separated from each other in a portion (so-called wrapped portion) on which the both ends of the conductive non-woven tape are overlapped (hereinafter, referred to as “the wrapped portion opens”), and therefore, a shielding effect may be reduced.

Another attaching method is a method (so-called spiral winding) of attaching the conductive non-woven tape to the electric wire in a state in which a part of the conductive non-woven tape in the width direction is overlapped while spirally winding the conductive non-woven tape around the electric wire. In a shielded electric wire manufactured by this attaching method, since the wrapped portion has a spiral shape, the wrapped portion is less likely to open even when the shielded electric wire is bent, as compared with the above-described shielded electric wire manufactured by the longitudinal attachment. However, since there is an adhesive layer between the conductive non-woven tapes in the wrapped portion, a spiral conductive path is formed by the conductive non-woven tape. Therefore, for example, when the conductive path formed by the conductive non-woven tape is used, like a coaxial cable, as a return path of a signal current, a magnetic field generated by the signal current flowing through the electric wire and a magnetic field generated by a return current flowing through the conductive non-woven tape are less likely to cancel each other out, and therefore, the shielding effect may be reduced as compared with the above-described shielded electric wire manufactured by the longitudinal attachment.

### SUMMARY OF INVENTION

Aspect of non-limiting embodiments of the present disclosure relates to provide a shielded electric wire having an excellent shielding effect and a conductive non-woven tape.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the invention, there is provided a shielded electric wire comprising:
an electric wire; and
a conductive non-woven tape wound spirally around a periphery of the electric wire, wherein
the conductive non-woven tape includes a conductive non-woven fabric and an adhesive layer located on one surface of the conductive non-woven fabric, and the conductive non-woven tape is spirally wound around the periphery of the electric wire with a winding pitch of t/3 or more and t/2 or less to form a wrapped portion in which the conductive non-woven tape is overlapped, where t is a width of the conductive non-woven tape, and
the adhesive layer is located in a different position from the wrapped portion, the adhesive layer has an adhesive force of 2.0 N/19 mm or more measured by an adhesive force test in accordance with JIS C 2107, the adhesive layer has a width of t/10 or more, and the adhesive layer has a thickness of 0.01 mm or more and not more than a thickness of the conductive non-woven fabric.

According to an other aspect of the invention, there is provided a conductive non-woven tape comprising:
a conductive non-woven fabric; and
an adhesive layer located on one surface of the conductive non-woven fabric, wherein
the adhesive layer has an adhesive force of 2.0 N/19 mm or more measured by an adhesive force test in accordance with JIS C 2107, the adhesive layer is located only between an end and a location separated from the end by a distance t/2 in a width direction of the conductive non-woven fabric, the adhesive layer has a width of t/10 or more, and the adhesive layer has a thickness of 0.01 mm or more and not more than a thickness of the conductive non-woven fabric, where t is a width of the conductive non-woven fabric.

### BRIEF DESCRIPTION OF DRAWINGS

Exemplary embodiment(s) of the present invention will be described in detail based on the following figures, wherein:

FIG. 1 is a perspective view illustrating a shielded electric wire according to an embodiment of the present invention,

FIG. 2A is a schematic view illustrating a cross-section of a conductive non-woven tape used in the shielded electric wire illustrated in FIG. 1 when the conductive non-woven tape is cut along a plane orthogonal to a longitudinal direction,

FIG. 2B is an enlarged view of a part A in FIG. 2A,

FIG. 2C is an enlarged view of a part B in FIG. 2B,

FIG. 3 is a schematic view illustrating a cross-section of the shielded electric wire illustrated in FIG. 1 (particularly, a periphery of the conductive non-woven tape) when the shielded electric wire is cut along a plane parallel to the longitudinal direction,

FIG. 4A is a schematic view illustrating a state of a magnetic field generated in a shielded electric wire prepared as Reference Example 1,

FIG. 4B is a schematic view illustrating a state of a magnetic field generated in the shielded electric wire according to the present embodiment,

FIG. 5A is a schematic view illustrating a relation between a thickness of an adhesive layer and the displacement of a conductive non-woven fabric when a shielded electric wire prepared as Reference Example 2 is bent, in the shielded electric wire,

FIG. 5B is a schematic view illustrating a relation between a thickness of an adhesive layer and the displacement of a conductive non-woven fabric when the shielded electric wire is bent, in the shielded electric wire according to the present embodiment,

FIG. 6 is a graph illustrating the shielding performance of the shielded electric wire according to the present embodiment and shielded electric wires prepared as Reference Examples 3 to 5,

FIG. 7 is a table illustrating details of the conductive non-woven tapes used in examples and comparative examples,

FIG. 8 is a first table illustrating test results of examples and comparative examples,

FIG. 9 is a second table illustrating test results of examples and comparative examples, and

FIG. 10 is a third table illustrating test results of an example and comparative examples.

### DESCRIPTION OF EMBODIMENTS

Hereinafter, the present invention will be described with reference to a preferred embodiment. The present invention is not limited to the embodiment to be described below, and the embodiment can be appropriately changed without departing from the gist of the present invention. In the embodiment to be described below, there may be portions in which illustration and description of a part of a configuration are omitted, and it is needless to say that a known or well-known technique is appropriately applied to the details of an omitted technique within a range in which no contradiction with the contents to be described below occurs.

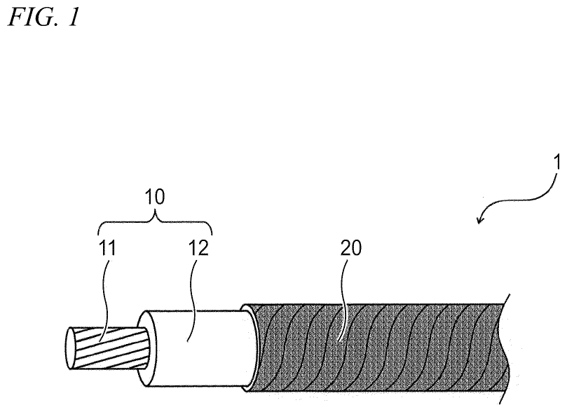

FIG. 1 is a perspective view illustrating a shielded electric wire 1 according to the embodiment of the present invention. As illustrated in FIG. 1, the shielded electric wire 1 according to the present embodiment includes a single electric wire 10 and a conductive non-woven tape 20 wound spirally around a periphery of the electric wire 10.

The electric wire 10 includes a conductor 11 made of, for example, copper, aluminum, or an alloy thereof, and a covering portion 12 having an insulation property that covers the conductor 11. In an example illustrated in FIG. 1, the conductor 11 of the electric wire 10 is a twisted wire obtained by twisting a plurality of strands. However, the conductor 11 may be a single wire made of a single strand. A plurality of electric wires 10 may be provided. The covering portion 12 is made of polyvinyl chloride (PVC), polypropylene (PP), and polyethylene (PE). However, the covering portion 12 may be made of silicone, polyurethane, nylon, or the like.

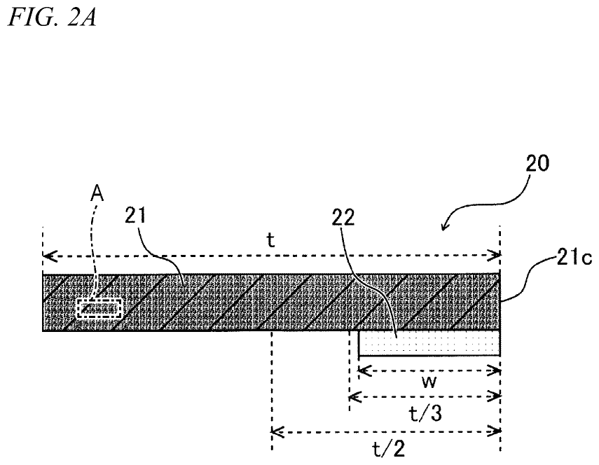

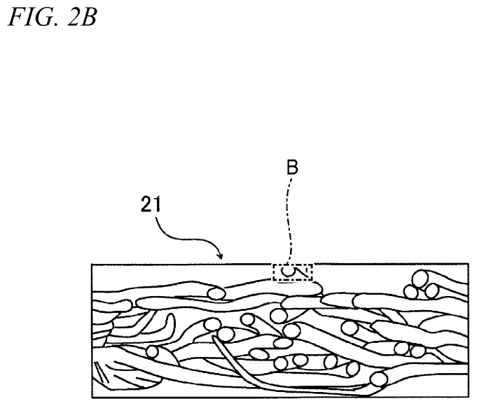

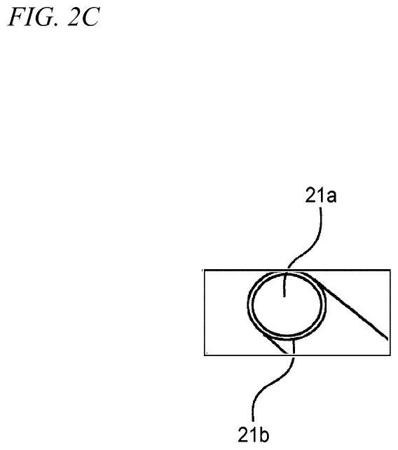

FIG. 2A is a schematic view illustrating a cross-section of the conductive non-woven tape 20 illustrated in FIG. 1 when the conductive non-woven tape 20 is cut along a plane orthogonal to a longitudinal direction. FIG. 2B is an enlarged view of a part A in FIG. 2A. FIG. 2C is an enlarged view of a part B in FIG. 2B. As illustrated in FIG. 2A, the conductive non-woven tape 20 includes a conductive non-woven fabric 21 and an adhesive layer 22 disposed on one surface (that is, front surface or back surface) of the conductive non-woven fabric 21.

As illustrated in FIGS. 2B and 2C, the conductive non-woven fabric 21 includes fibers 21a constituting a non-woven fabric, and plated portions 21b. The non-woven fabric is a sheet-shaped member in which the fibers 21a are intertwined without being woven. As illustrated in FIGS. 2B and 2C, the non-woven fabric has a structure in which the fibers 21a are disposed in a plurality of layers in a thickness direction in terms of manufacturing characteristics. The fibers 21a constituting the non-woven fabric are made of polyethylene terephthalate (PET), polypropylene, nylon, acrylic, glass fiber, carbon fiber, aramid fiber, Polyarylate fiber, or the like.

The plated portion 21b is a conductive metal covering the fiber 21a constituting the non-woven fabric. The plated portion 21b is made of, for example, copper, nickel, tin, silver, or an alloy of these metals. The plated portion 21b may be formed in a single layer to cover the fiber 21a constituting the non-woven fabric or may be formed in a plurality of layers. For example, the plating portion 21b may have a multi-layer structure in which a first layer made of copper is provided to cover the fiber 21a constituting the non-woven fabric, and a second layer made of tin is provided to cover the first layer.

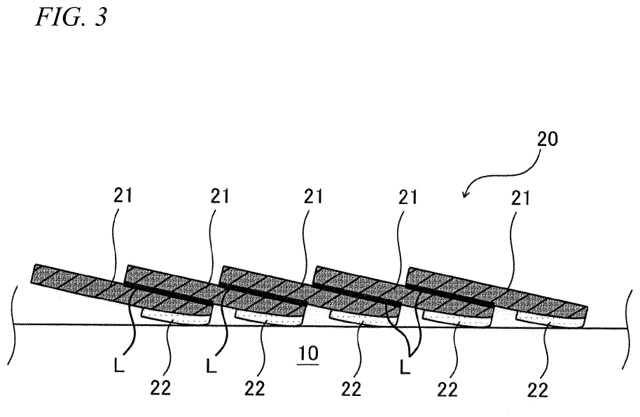

FIG. 3 is a schematic view illustrating a cross-section of the shielded electric wire 1 illustrated in FIG. 1 (particularly, a periphery of the conductive non-woven tape 20) when the shielded electric wire 1 is cut along a plane parallel to the longitudinal direction. As illustrated in FIG. 3, the adhesive layer 22 is disposed at a position different from that of a wrapped portion L when the conductive non-woven tape 20 is wound around the periphery of the electric wire 10. As illustrated in FIG. 3, the wrapped portion L is a portion in which parts of the conductive non-woven tape 20 are overlapped in a radial direction of the shielded electric wire 1. As illustrated in FIG. 3, in the present embodiment, the adhesive layer 22 is not interposed between the adjacent conductive non-woven fabrics 21 in a state in which the conductive non-woven tape 20 is spirally wound around the electric wire 10.

As illustrated in FIG. 2A, the adhesive layer 22 is disposed at an end portion on one side in a width direction of the conductive non-woven fabric 21. When a width of the conductive non-woven tape 20 (that is, a width of the conductive non-woven fabric 21) is t, the adhesive layer 22 is preferably disposed between an end 21c of the conductive non-woven fabric 21 and a location separated from the end 21c by a distance t/2 (that is, within a range indicated by t/2 in FIG. 2A). The adhesive layer 22 is more preferably disposed between the end 21c of the conductive non-woven fabric 21 and a location separated from the end 21c by a distance t/3 (that is, within a range indicated by t/3 illustrated in FIG. 2A).

Accordingly, when the conductive non-woven tape 20 is wound around the electric wire 10, in a case of the former “preferable” example, the adhesive layer 22 can be disposed at a position different from that of the wrapped portion L when a width of the wrapped portion L is ½ or less of the width t of the conductive non-woven tape 20 (so-called half wrap or less), and in a case of the latter “more preferable” example, the adhesive layer 22 can be disposed at a position different from that of the wrapped portion L when the width of the wrapped portion L is ⅔ or less of the width t of the conductive non-woven tape 20 (so-called ⅔ wrap or less).

Particularly, the adhesive layer 22 is preferably disposed such that one end of the adhesive layer 22 is located at the end 21c in a width direction of the conductive non-woven fabric 21 and the other end of the adhesive layer 22 is located within the above-described range. Accordingly, when the conductive non-woven tape 20 is wound around the electric wire 10, the adhesive layer 22 is easily disposed at a position different from that of the wrapped portion L.

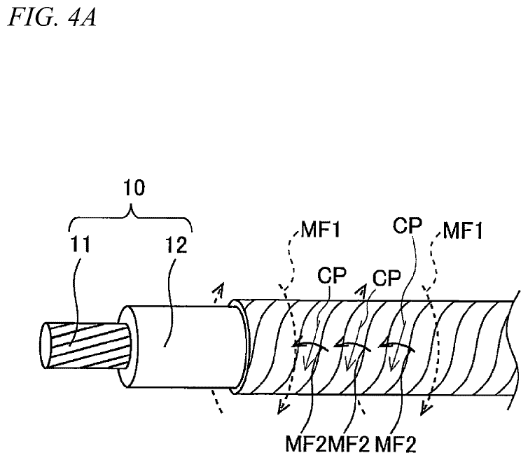

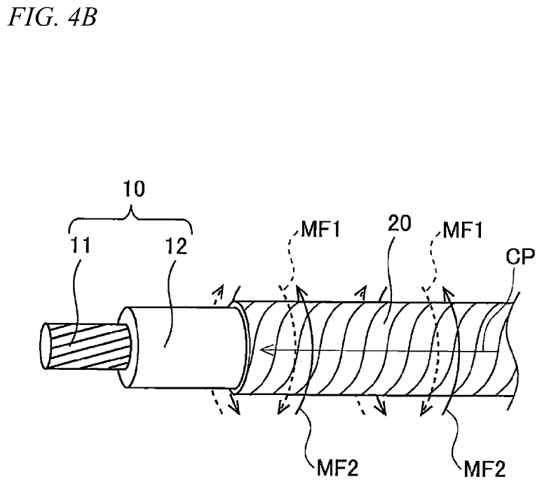

In the shielded electric wire 1 according to the present embodiment, the shielding performance is improved as compared with Reference Example 1 in which an adhesive layer is interposed between conductive non-woven fabrics (see FIG. 4A). A principle is as follows.

FIG. 4A is a schematic view illustrating a state of a magnetic field generated in a shielded electric wire prepared as Reference Example 1, and FIG. 4B is a schematic view illustrating a state of a magnetic field generated in the shielded electric wire 1 according to the present embodiment. As illustrated in FIGS. 4A and 4B, when a current flows through the electric wire 10 in an extension direction of the conductor 11 (in this example, rightward), a magnetic field MF1 (dashed line) is generated around the current. On the other hand, when the adhesive layer 22 is interposed between the conductive non-woven fabrics 21, a spiral conductive path CP is formed by the conductive non-woven tape 20 as in Reference Example 1 illustrated in FIG. 4A. Therefore, for example, when the conductive non-woven fabric 21 of the conductive non-woven tape 20 is used, like a coaxial cable, as a return path of a signal current, a magnetic field MF2 (solid line) is generated around the conductive non-woven fabric 21 by a return current flowing spirally from right to left through the conductive path CP. Since a direction of the magnetic field MF2 and a direction of the magnetic field MF1 intersect but are not opposite to each other, the magnetic field MF2 may not sufficiently cancel out the magnetic field MF1. On the other hand, when the adhesive layer 22 is at a position different from the wrapped portion L as illustrated in FIG. 3, as illustrated in FIG. 4B, the conductive path CP having a tubular shape is formed along a longitudinal direction of the electric wire 10 by the conductive non-woven fabric 21. Therefore, the magnetic field MF2 (solid line) is generated around the conductive non-woven fabric 21 by a current flowing linearly from right to left through the conductive path CP. Since a direction of the magnetic field MF2 and the direction of the magnetic field MF1 (dashed line) are opposite to each other, the magnetic field MF2 can efficiently cancel out the magnetic field MF1 as compared with Reference Example 1.

As described above, in the shielded electric wire 1 according to the present embodiment, since the adhesive layer 22 is disposed at a position different from that of the wrapped portion L, the shielding performance is improved.

Further, in the shielded electric wire 1 according to the present embodiment, a winding pitch of the conductive non-woven tape 20, an adhesive force of the adhesive layer 22, a width w of the adhesive layer 22, and a thickness AT of the adhesive layer 22 are determined as follows to maintain the sufficient shielding performance even when the shielded electric wire 1 is bent (for example, when the shielded electric wire 1 is bent such that a shape of a surface on a bent inner side of the shielded electric wire 1 is a circular arc having a radius of 30 mm at a bent portion of the shielded electric wire 1. Hereinafter, referred to as when “R30 bending” is performed).

In the shielded electric wire 1 according to the present embodiment, when the width of the conductive non-woven tape 20 is t, the winding pitch of the conductive non-woven tape 20 is t/3 or more and t/2 or less. The winding pitch represents a length that the conductive non-woven tape 20 travels in an axial direction of the electric wire 10 when the conductive non-woven tape 20 is wound around an outer periphery of the electric wire 10 for one lap. The winding pitch corresponds to a width of a portion of the conductive non-woven tape 20 other than the wrapped portion L. When the winding pitch is smaller than t/3 (that is, the width of the wrapped portion L is larger than 2t/3), the shielded electric wire 1 becomes too hard due to the winding of the conductive non-woven tape 20, and the bending (for example, the above-described R30 bending) of the shielded electric wire 1 may be difficult. When the winding pitch is larger than t/2 (that is, the width of the wrapped portion L is smaller than t/2), the width of the wrapped portion L is small, and therefore, there may be a location where the conductive non-woven fabrics 21 are not overlapped, and the covering portion 12 of the electric wire 10 may be exposed during the R30 bending.

The adhesive layer 22 has an adhesive force of 2.0 N/19 mm or more with respect to a stainless steel plate (that is, a SUS steel plate), which is measured by an adhesive force test in accordance with JIS C 2107. An experiment conducted by the inventor, and the like has revealed that the adhesive layer 22 having such an adhesive force has an adhesive force of 0.6 N/19 mm or more with respect to the covering portion 12 (for example, the covering portion 12 made of any of PVC, PP, PE, silicone, polyurethane, and nylon) of the electric wire 10. Further, the width w of the adhesive layer 22 (see FIG. 2A) is t/10 or more. By determining the adhesive force and the width w of the adhesive layer 22 as described above, the conductive non-woven tape 20 is less likely to be displaced during the R30 bending.

The thickness AT of the adhesive layer 22 is 0.01 mm or more and not more than a thickness of the conductive non-woven fabric 21. When the thickness AT of the adhesive layer 22 is 0.01 mm or more, the adhesive layer 22 can be appropriately formed on a surface of the conductive non-woven fabric 21 in terms of processing accuracy or the like, and when the thickness AT of the adhesive layer 22 is not more than the thickness of the conductive non-woven fabric 21, a state in which the conductive non-woven fabrics 21 are in contact with each other in the wrapped portion L during the R30 bending and the conductive path CP extending in the longitudinal direction of the shielded electric wire 1 can be maintained as described later.

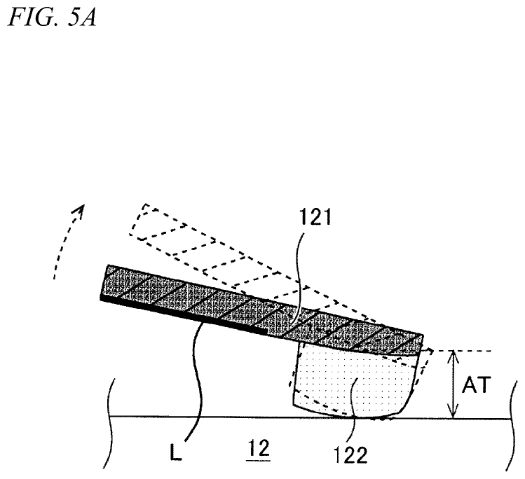

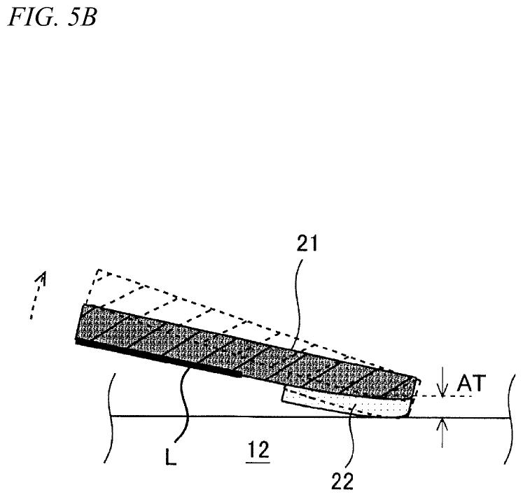

FIG. 5A is a schematic view illustrating a relation between the thickness AT of an adhesive layer 122 and the displacement of a conductive non-woven fabric 121 when a shielded electric wire prepared as Reference Example 2 is bent, in the shielded electric wire, and FIG. 5B is a schematic view illustrating a relation between the thickness AT of the adhesive layer 22 and the displacement of the conductive non-woven fabric 21 when the shielded electric wire 1 is bent, in the shielded electric wire 1 according to the present embodiment. In Reference Example 2 illustrated in FIG. 5A, the thickness AT of the adhesive layer 122 exceeds a thickness of the conductive non-woven fabric 121. Therefore, the conductive non-woven fabric 121 is separated from the covering portion 12, and a contact pressure between the conductive non-woven fabrics 121 tends to decrease due to the elasticity of the adhesive layer 122 or the like. In addition, as illustrated in FIG. 5A, when there is no adhesive layer 122 in the wrapped portion L, the conductive non-woven tape rotates to be separated from the covering portion 12 on a bent outer side during the bending. Here, in Reference Example 2 illustrated in FIG. 5A, since the thickness AT of the adhesive layer 122 exceeds the thickness of the conductive non-woven fabric 121, an amount of rotation of the conductive non-woven fabric 121 during rotation tends to increase.

On the other hand, in the present embodiment illustrated in FIG. 5B, the thickness AT of the adhesive layer 22 is not more than the thickness of the conductive non-woven fabric 21. Therefore, the contact pressure between the conductive non-woven fabrics 21 tends to increase. In addition, as illustrated in FIG. 5B, the conductive non-woven tape 20 rotates to be separated from the covering portion 12 on the bent outer side during the bending, but an amount of rotation tends to decrease. Accordingly, in the shielded electric wire 1 according to the present embodiment, by setting the thickness AT of the adhesive layer 22 to be not more than the thickness of the conductive non-woven fabric 21 (more specifically, the smaller the thickness AT of the adhesive layer 22, the better), the state in which the conductive non-woven fabrics 21 are in contact with each other in the wrapped portion L is maintained even during the R30 bending, and the conductive path CP extending in the longitudinal direction of the shielded electric wire 1 can be maintained.

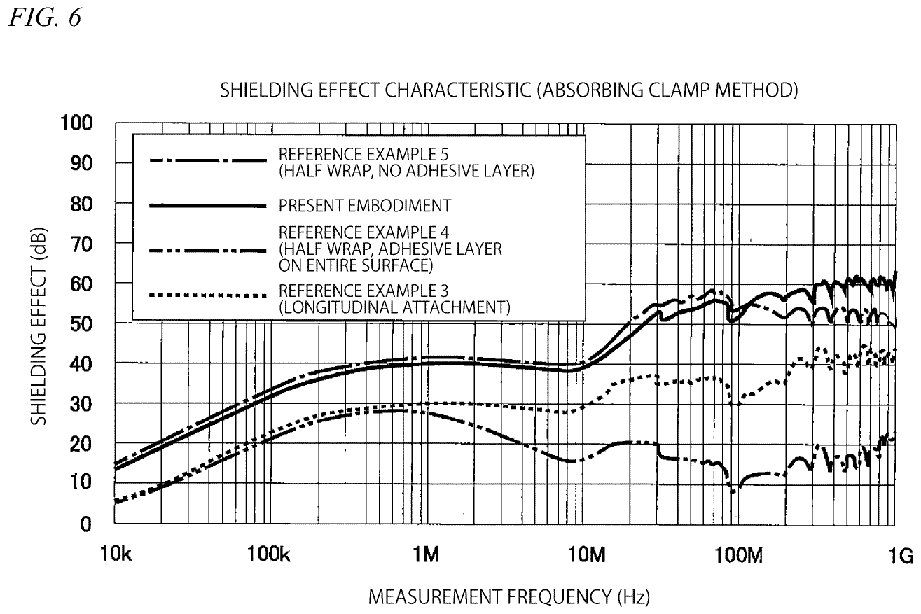

FIG. 6 is a graph illustrating the shielding performance of the shielded electric wire according to the present embodiment and shielded electric wires according to Reference Examples 3 to 5. FIG. 6 illustrates the shielding performance at bent portions during the R30 bending.

As Reference Example 3, a shielded electric wire was prepared in which the conductive non-woven fabric is wound around an electric wire with “longitudinal attachment”. As Reference Example 4, a shielded electric wire was prepared in which a conductive non-woven tape, in which an adhesive layer is formed on an “entire surface” of one surface of the conductive non-woven fabric, is wound around the electric wire in “spiral winding” such that a width of a wrapped portion was ½ of a width of the conductive non-woven tape (that is, wound with a “half wrap”). As illustrated in FIG. 5, the shielding performance of the shielded electric wire according to Reference Example 4 is inferior to the shielding performance of the shielded electric wire according to Reference Example 3 because no conductive path in the longitudinal direction is formed.

With respect to these, as described above, the shielded electric wire 1 according to the present embodiment has structures described with reference to FIGS. 1 to 3. In the shielded electric wire 1, the conductive non-woven tape 20 is wound around the electric wire 10 with the half lap. The shielding performance of the shielded electric wire 1 according to the present embodiment is superior to the shielding performance of the shielded electric wires according to Reference Examples 3 and 4. As Reference Example 5, a shielded electric wire was prepared in which a conductive non-woven tape having no adhesive layer (that is, only the conductive non-woven fabric) was wound around the electric wire with the “half wrap”. The shielded electric wire according to Reference Example 5 has the same shielding performance as that of the shielded electric wire according to the present embodiment because the conductive non-woven fabrics are less likely to be separated from each other in a wrapped portion even during the R30 bending.

As illustrated in FIG. 6, when a frequency is 100 MHz or more, the shielding performance of the shielded electric wire according to Reference Example 5 is inferior to the shielding performance of the shielded electric wire according to the present embodiment. This is because, in Reference Example 5, even when the conductive non-woven fabrics are not completely separated from each other in the wrapped portion, since there is no adhesive layer, a small gap is likely to occur between the conductive non-woven fabrics during the bending. Further, regarding the shielded electric wire according to Reference Example 5, when the shielded electric wire is left in a bent state for a long time, the conductive non-woven fabrics are gradually separated from each other in the wrapped portion, and thus the shielding performance may be greatly reduced.

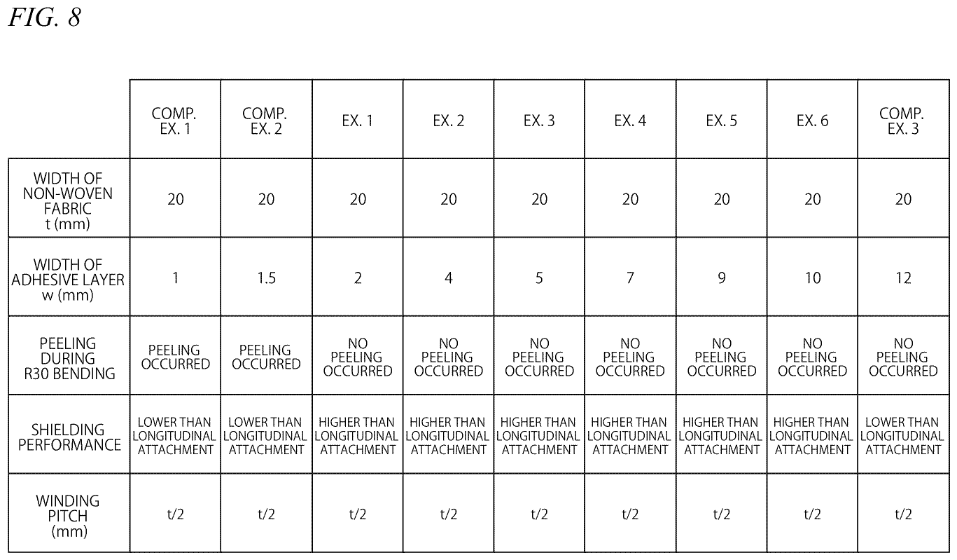

Next, a relation between the width t of a conductive non-woven tape, the width w of an adhesive layer, the winding pitch, and the shielding performance will be described with reference to FIGS. 8 to 10. In Examples 1 to 7 and Comparative Examples 1 to 8 illustrated in FIGS. 8 to 10, conductive non-woven tapes having the width t and the width w of the adhesive layer illustrated in FIGS. 8 to 10 were spirally wound at the winding pitch illustrated in FIGS. 8 to 10 around a plurality of types of electric wires having different conductor cross-sectional areas (specifically, a plurality of types of electric wires each having a conductor cross-sectional area of 10 sq or more and 150 sq or less and an outer diameter of 5.6 mm or more and 22.0 mm or less).

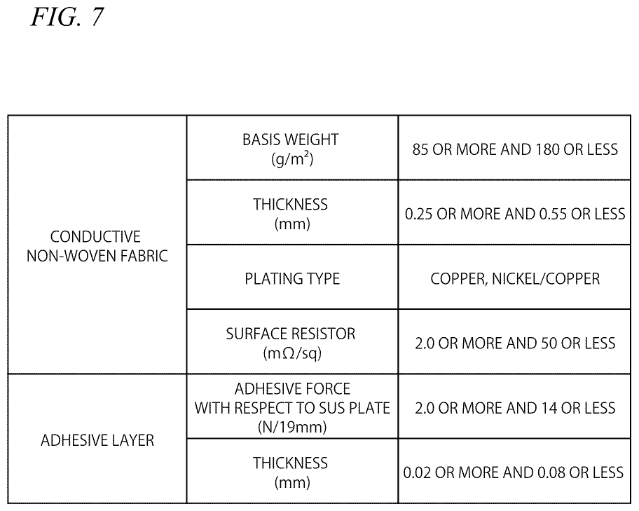

FIG. 7 is a table illustrating details of the conductive non-woven tapes used in Examples 1 to 7 and Comparative Examples 1 to 8. That is, non-woven fabrics constituting conductive non-woven fabrics each have a weight per unit area (basis weight) of 85 g/m² or more and 180 g/m² or less. The conductive non-woven fabrics each have a thickness of 0.25 mm or more and 0.55 mm or less. The conductive non-woven fabrics each include a plated portion having a single-layer structure made of copper, or a multilayer structure in which an inner layer is made of copper and an outer layer is made of nickel. The conductive non-woven fabrics each have a surface resistor value of 2.0 mΩ/sq or more and 50 mΩ/sq or less. “mΩ/sq” is an abbreviation of “mΩ/square”.

The adhesive layers each have an adhesive force of 2.0 N/19 mm or more and 14 N/19 mm or less (specifically, the adhesive force with respect to the SUS steel plate, which is measured by the adhesive force test in accordance with JIS C 2107). The adhesive layers each have a thickness of 0.02 mm or more and 0.08 mm or less. In Examples 1 to 7 and Comparative Examples 1 to 8, a plurality of samples satisfying parameters illustrated in FIG. 7 were prepared using the plurality of types of electric wires described above, and tests to be described later were performed using the plurality of samples. FIGS. 8 to 10 illustrate test results. In all of the tests using the plurality of samples, the test results illustrated in FIGS. 8 to 10 were commonly obtained. As described above, the conductive non-woven tape that exhibits the adhesive force of 2.0 N/19 mm or more with respect to the SUS steel plate exhibits the adhesive force of 0.6 N/19 mm or more with respect to a covering portion of the electric wire used for the test.

Assuming that shielded electric wires according to Examples 1 to 7 and Comparative Examples 1 to 8 are routed in a vehicle or the like and maintained in an R30 bent state for a long time, a bending test was performed in which the R30 bending is repeatedly performed many times. In the bending test, the shielded electric wires according to Examples 1 to 7 and Comparative Examples 1 to 8 were bent 90 degrees from a straight state and then returned to the straight state again by using a mandrel having a radius of 30 mm, this reciprocating bending was performed at a speed of 60 rpm for 50,000 times.

Then, regarding Examples 1 to 7 and Comparative Examples 1 to 8, it was observed whether the conductive non-woven tape was peeled off from the electric wire after the bending test, and the shielding performance of the shielded electric wire after the bending test was compared with the shielding performance of the shielded electric wire in which the conductive non-woven fabric was longitudinally attached as in Reference Example.

As illustrated in FIG. 8, in all of Examples 1 to 6 and Comparative Examples 1 to 3, the conductive non-woven tapes each have the width t of 20 mm. The width w of the adhesive layer was 2 mm in Example 1, 4 mm in Example 2, 5 mm in Example 3, 7 mm in Example 4, 9 mm in Example 5, and 10 mm in Example 6. The width w of the adhesive layer was 1 mm in Comparative Example 1, 1.5 mm in Comparative Example 2, and 12 mm in Comparative Example 3. One end of the adhesive layer is located at an end of the conductive non-woven fabric in Examples 1 to 6 and Comparative Examples 1 to 3. In Examples 1 to 6 and Comparative Examples 1 to 3, the winding pitch of the conductive non-woven tape was t/2 (=10 mm).

In the shielded electric wires according to Examples 1 to 6, peeling of the conductive non-woven tape did not occur in all of the plurality of samples described above. Further, the shielding performance of the shielded electric wires according to Examples 1 to 6 was higher than the shielding performance of the shielded electric wire in which the conductive non-woven fabric was longitudinally attached.

On the other hand, in Comparative Examples 1 and 2, since the width w of the adhesive layers was small, it was difficult to maintain the state in which the conductive non-woven tape was wound around the electric wire, and peeling of the conductive non-woven tape occurred in the shielded electric wires according to Comparative Examples 1 and 2. As a result, the shielding performance of the shielded electric wires according to Comparative Examples 1 and 2 was lower than the shielding performance of the shielded electric wire in which the conductive non-woven fabric was longitudinally attached. In Comparative Example 3, since the width w of the adhesive layer was large, the peeling of the conductive non-woven tape did not occur. However, since the adhesive layer was interposed between the conductive non-woven fabrics in the wrapped portion due to the large width w of the adhesive layer, the shielding performance of the shielded electric wire according to Comparative Example 3 was lower than the shielding performance of the shielded electric wire in which the conductive non-woven fabric was longitudinally attached.

Therefore, it was found from Examples 1 to 6 and Comparative Examples 1 and 2 that when the adhesive force of the adhesive layer with respect to the SUS steel plate was 2.0 N/19 mm or more (in other words, 0.6 N/19 mm or more with respect to the electric wire) and the width w of the adhesive layer was 2 mm or more (that is, t/10 or more), the peeling of the conductive non-woven tape did not occur, and the shielding performance was superior to that of the shielded electric wire in which the conductive non-woven fabric was longitudinally attached. Further, it was found from Examples 1 to 6 and Comparative Example 3 that when the adhesive layer was interposed between the conductive non-woven fabrics in the wrapped portion, the conductive path along the longitudinal direction of the shielded electric wire was not formed, and thus the shielding performance was inferior to that of the shielded electric wire in which the conductive non-woven fabric was longitudinally attached.

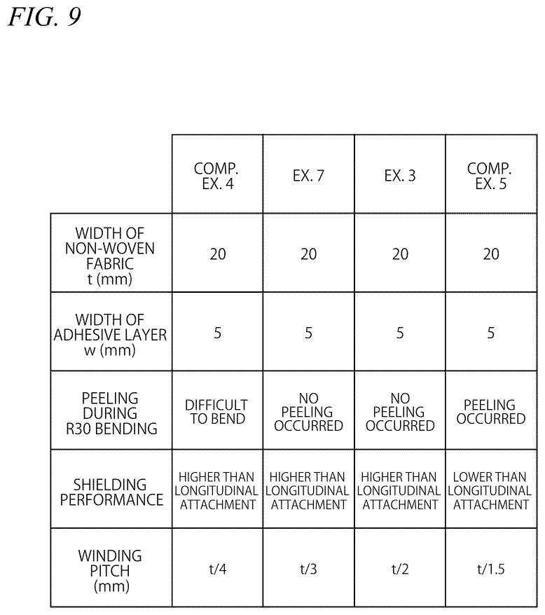

Next, as illustrated in FIG. 9, in all of Examples 3 and 7 and Comparative Examples 4 and 5, the conductive non-woven tapes each have the width t of 20 mm, and the adhesive layers each have the width w of 5 mm. The winding pitch of the conductive non-woven tape is t/3 (≈6.67 mm) in Example 7, t/2 (=10 mm) in Example 3, t/4 (=5 mm) in Comparative Example 4, and t/1.5 (≈13.3 mm) in Comparative Example 5. The one end of the adhesive layer is located at the end of the conductive non-woven fabric also in Examples 3 and 7 and Comparative Examples 4 and 5 illustrated in FIG. 9.

In the shielded electric wires according to Examples 3 and 7, the peeling of the conductive non-woven tape did not occur in all of the plurality of samples described above. Further, the shielding performance of the shielded electric wires according to Examples 3 and 7 was higher than the shielding performance of the shielded electric wire in which the conductive non-woven fabric was longitudinally attached.

Further, the shielding performance of the shielded electric wire according to Comparative Example 4 was higher than the shielding performance of the shielded electric wire in which the conductive non-woven fabric was longitudinally attached. However, in the shielded electric wire according to Comparative Example 4, since the winding pitch was too small, it was difficult to perform the R30 bending itself. In Comparative Example 5, since the winding pitch was too large, the peeling of the conductive non-woven tape occurred. As a result, the shielding performance of the shielded electric wire according to Comparative Example 5 was lower than the shielding performance of the shielded electric wire in which the conductive non-woven fabric was longitudinally attached.

Therefore, it was found from Examples 3 and 7 and Comparative Example 4 that it is difficult to perform the R30 bending when the winding pitch of the conductive non-woven tape is t/4, and the R30 bending can be performed when the winding pitch of the conductive non-woven tape is t/3 or more. Further, it was found from Examples 3 and 7 and Comparative Example 5 that the peeling of the conductive non-woven tape occurred during the R30 bending when the winding pitch of the conductive non-woven tape was t/1.5, but when the winding pitch of the conductive non-woven tape was t/2 or less, the peeling of the conductive non-woven tape did not occur, and the conductive path along the longitudinal direction of the electric wire was formed, and thus the shielding performance was superior to that of the shielded electric wire in which the conductive non-woven fabric was longitudinally attached.

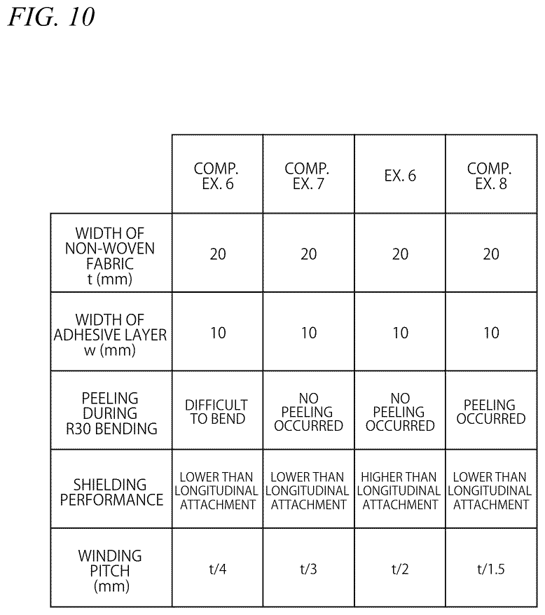

Next, as illustrated in FIG. 10, in all of Example 6 and Comparative Examples 6 to 8, the conductive non-woven tapes each have the width t of 20 mm, and the adhesive layers each have the width w of 10 mm. The winding pitch of the conductive non-woven tape is t/2 (=10 mm) in Example 6, t/4 (=5 mm) in Comparative Example 6, t/3 (≈6.67 mm) in Comparative Example 7, and t/1.5 (≈13.3 mm) in Comparative Example 8. The one end of the adhesive layer is located at the end of the conductive non-woven fabric also in Example 6 and Comparative Examples 6 to 8 illustrated in FIG. 10.

In the shielded electric wire according to Example 6, as described with reference to FIG. 8, the peeling of the conductive non-woven tape did not occur in all of the plurality of samples described above. Further, the shielding performance of the shielded electric wire according to Example 6 was higher than the shielding performance of the shielded electric wire in which the conductive non-woven fabric was longitudinally attached.

In the shielded electric wire according to Comparative Example 6, since the winding pitch was too small, it was difficult to perform the R30 bending itself. In Comparative Example 6, since the adhesive layer was interposed between the conductive non-woven fabrics in the wrapped portion due to the large width w of the adhesive layer, the shielding performance of the shielded electric wire according to Comparative Example 6 was lower than the shielding performance of the shielded electric wire in which the conductive non-woven fabric was longitudinally attached.

In the shielded electric wire according to Comparative Example 7, since the winding pitch was appropriate, the peeling of the conductive non-woven tape did not occur. However, in Comparative Example 7, since the adhesive layer was interposed between the conductive non-woven fabrics in the wrapped portion due to the large width w of the adhesive layer, the shielding performance of the shielded electric wire according to Comparative Example 7 was lower than the shielding performance of the shielded electric wire in which the conductive non-woven fabric was longitudinally attached.

In Comparative Example 8, the adhesive layer was not interposed between the conductive non-woven fabrics in the wrapped portion, but the winding pitch was too large as in Comparative Example 5, and therefore, the peeling of the conductive non-woven tape occurred, and the shielding performance of the shielded electric wire according to Comparative Example 8 was lower than the shielding performance of the shielded electric wire in which the conductive non-woven fabric was longitudinally attached.

Therefore, it was found from Example 6 and Comparative Examples 6 to 8 that it is difficult to perform the R30 bending when the winding pitch of the conductive non-woven tape is t/4, and the R30 bending can be performed when the winding pitch of the conductive non-woven tape is t/3 or more. Further, it was also found from Comparative Example 7 that even when the winding pitch of the conductive non-woven tape was t/3, the shielding performance was reduced when the adhesive layer was interposed between the conductive non-woven fabrics in the wrapped portion. Further, it was found from Example 6 and Comparative Examples 7 and 8 that the peeling of the conductive non-woven tape occurred during the R30 bending when the winding pitch of the conductive non-woven tape was t/1.5, but the peeling of the conductive non-woven tape did not occur when the winding pitch of the conductive non-woven tape was t/2 or less. It was found, in Example 6 in which the adhesive layer was not interposed between the conductive non-woven fabrics in the wrapped portion, that since the conductive path is formed along the longitudinal direction of the electric wire, the shielding performance was superior to that of the shielded electric wire in which the conductive non-woven fabric was longitudinally attached.

As described above, in the shielded electric wire 1 according to the present embodiment using the conductive non-woven tape 20, since the adhesive layer 22 is disposed at a position different from that the wrapped portion L, the conductive non-woven fabrics 21 are overlapped in the wrapped portion L, and the conductive path CP along the longitudinal direction of the electric wire 10 is formed by the conductive non-woven fabric 21. Thus, even when the conductive non-woven tape 20 is spirally wound, the shielded electric wire 1 can exhibit an appropriate shielding effect.

Further, in the shielded electric wire 1, the winding pitch is t/3 or more and t/2 or less, the width w of the adhesive layer 22 is t/10 or more, the adhesive force of the adhesive layer 22 with respect to the SUS steel plate is 2.0 N/19 mm or more (in other words, 0.6 N/19 mm or more with respect to the electric wire 10), the thickness AT of the adhesive layer 22 is not more than the thickness of the conductive non-woven fabric 21, and therefore, the conductive non-woven tape 20 is less likely to be displaced during the R30 bending, the state in which the conductive non-woven fabrics 21 are in contact with each other in the wrapped portion L is maintained, thereby avoiding a decrease in the shielding effect. More specifically, since the width w and the adhesive force of the adhesive layer 22 satisfy the above ranges, the conductive non-woven tape 20 is less likely to be displaced. Further, since the winding pitch of the conductive non-woven tape 20 is t/3 or more, there is no problem in bending of the shielded electric wire 1, and since the winding pitch of the conductive non-woven tape 20 is t/2 or less, exposure of the covering portion 12 is also prevented when the shielded electric wire 1 is bent. Further, since the thickness AT of the adhesive layer 22 is not more than the thickness of the conductive non-woven fabric 21, it is possible to maintain a state in which the conductive non-woven tape 20 is difficult to move and the conductive non-woven fabrics 21 are in contact with each other. The thickness AT of the adhesive layer 22 is set to 0.01 mm or more in consideration of manufacturing difficulties.

As described above, the shielded electric wire 1 according to the present embodiment is excellent in the shielding effect.

The present invention is not limited to the above-described embodiment, and various modifications can be adopted within the scope of the present invention. For example, the present invention is not limited to the above-described embodiment, and modifications, improvements, and the like can be made appropriately. In addition, materials, shapes, sizes, numbers, arrangement positions, or the like of components in the above-described embodiment are freely selected and are not limited as long as the present invention can be implemented.

For example, in FIG. 2A, examples, and the like, the one end of the adhesive layer 22 is located at the end 21c of the conductive non-woven fabric 21. However, the one end of the adhesive layer 22 may be disposed at a position separated from the end 21c.

### INDUSTRIAL APPLICABILITY

The shielded electric wire and the conductive non-woven tape of the present invention are excellent in the shielding effect. The present invention having this effect may be used, for example, as a wire harness mounted on an automatic vehicle or the like.

### REFERENCE SIGNS LIST

1: shielded electric wire
10: electric wire
12: covering portion
20: conductive non-woven tape
21: conductive non-woven fabric
22: adhesive layer
AT: thickness of adhesive layer
L: wrapped portion
T: width of conductive non-woven tape
W: width of adhesive layer

What is claimed is:

1. A shielded electric wire comprising:
an electric wire; and
a conductive non-woven tape wound spirally around a periphery of the electric wire, wherein
the conductive non-woven tape includes a conductive non-woven fabric and an adhesive layer located on one surface of the conductive non-woven fabric, and the conductive non-woven tape is spirally wound around the periphery of the electric wire with a winding pitch of t/3 or more and t/2 or less to form a wrapped portion in which the conductive non-woven tape is overlapped, where t is a width of the conductive non-woven tape, and
the adhesive layer is located in a different position from the wrapped portion, the adhesive layer has an adhesive force of 2.0 N/19 mm or more measured by an adhesive force test in accordance with JIS C 2107, the adhesive layer has a width of t/10 or more, and the adhesive layer has a thickness of 0.01 mm or more and not more than a thickness of the conductive non-woven fabric.

2. A conductive non-woven tape comprising:
a conductive non-woven fabric; and
an adhesive layer located on one surface of the conductive non-woven fabric, wherein
the adhesive layer has an adhesive force of 2.0 N/19 mm or more measured by an adhesive force test in accordance with JIS C 2107, the adhesive layer is located only between an end and a location separated from the end by a distance t/2 in a width direction of the conductive non-woven fabric, the adhesive layer has a width of t/10 or more, and the adhesive layer has a thickness of 0.01 mm or more and not more than a thickness of the conductive non-woven fabric, where t is a width of the conductive non-woven fabric.
